(19) United States
(12) Patent Application Publication
(10) Pub. No.: US 2025/0274399 A1
(43) Pub. Date: Aug. 28, 2025

(54) BANDWIDTH SCALING KNOBS FOR PCIE/CXL.IO USING UNORDERED IO AS PRIMARY VEHICLE

(71) Applicants: Debendra DAS SHARMA, Saratoga, CA (US); Swadesh CHOUDHARY, Mountain View, CA (US)

(72) Inventors: Debendra DAS SHARMA, Saratoga, CA (US); Swadesh CHOUDHARY, Mountain View, CA (US)

(21) Appl. No.: 19/177,554

(22) Filed: Apr. 12, 2025

Related U.S. Application Data
(60) Provisional application No. 63/633,614, filed on Apr. 12, 2024.

(51) Int. Cl. H04L 47/74; H04L 47/2441; H04L 69/22

(52) U.S. Cl. CPC H04L 47/748; H04L 47/2441; H04L 69/22

(57) ABSTRACT

This disclosure describes systems, methods, and devices related to bandwidth scaling. A device may receive data indicative of a negotiated data rate between a host and the device. The device may determine a throttle mode based on advertised bandwidth capabilities of the device, including support for non-unordered input output (non-UIO) virtual channels. The device may encode non-UIO virtual channel data within a Flit based on the throttle mode. The device may transmit the Flit based on the negotiated data rate.

### CROSS-REFERENCE TO RELATED APPLICATION(S)

This application claims the benefit of U.S. Provisional Application No. 63/633,614, filed Apr. 12, 2024, the disclosure of which is incorporated herein by reference as if set forth in full.

### BACKGROUND

Peripheral Component Interconnect Express (PCIe) Input/Output (I/O) speeds are rapidly scaling from 64 Gigatransfers per second (GT/s) (gen6) to 128GT/s (gen7) and beyond. Early adopters include applications in artificial intelligence (AI) and networking. Delivering bandwidth as a single stream with PCIe ordering constraints is proving costly due to bandwidth demands exceeding on-chip interconnect levels. There is a need for a method to deliver this bandwidth through aggregate bandwidth using multiple paths, where preserving ordering at every intermediate point is challenging.

### BRIEF DESCRIPTION OF THE DRAWINGS

FIG. 1 depicts an illustrative schematic diagram for bandwidth scaling, in accordance with one or more example embodiments of the present disclosure.

FIG. 2 illustrates a flow diagram of a process for a bandwidth scaling system, in accordance with one or more example embodiments of the present disclosure.

FIG. 3 illustrates an embodiment of a block diagram for a computing system including a processor, in accordance with one or more example embodiments of the present disclosure.

FIG. 4 illustrates an example system, in accordance with one or more example embodiments of the present disclosure.

FIG. 5 illustrates an example system implemented as system on chip (SoC), in accordance with one or more example embodiments of the present disclosure.

Certain implementations will now be described more fully below with reference to the accompanying drawings, in which various implementations and/or aspects are shown. However, various aspects may be implemented in many different forms and should not be construed as limited to the implementations set forth herein; rather, these implementations are provided so that this disclosure will be thorough and complete, and will fully convey the scope of the disclosure to those skilled in the art. Like numbers in the figures refer to like elements throughout. Hence, if a feature is used across several drawings, the number used to identify the feature in the drawing where the feature first appeared will be used in later drawings.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

As PCI Express (PCIe)/Compute Express Link (CXL) Input/Output (io) speeds scale rapidly from 64 Gigatransfers per second (GT/s) (gen6) to 128GT/s (gen7) and beyond, the early adopters are accelerator applications around AI and networking. Delivering bandwidth with the PCIe ordering constraints as a single stream is proving to be prohibitively expensive as the bandwidths are exceeding those available at the on-chip interconnect level per connection (e.g., a mesh stop in a 2D connected mesh infrastructure). Thus, the means to deliver this bandwidth is aggregate bandwidth through multiple paths, where preserving ordering at every intermediate point is challenging. The Unordered IO (UIO) Engineering Change Notice (ECN) introduced in PCIe 6.0 Specification is emerging as the primary vehicle for bandwidth scaling in the future that sidesteps these issues. On the device side, most of these applications do not require high bandwidth ordered traffic and they would benefit from scaling Unordered IO bandwidth independent of the traditional Ordered IO bandwidth-achieving synergy for back-side fabrics as well as for device to host connections.

CXL, or Compute Express Link, is an open standard interconnect designed to facilitate high-speed communication between processors, memory, and other hardware components. It is built on the PCIe physical layer, leveraging existing technology to provide low latency and high bandwidth data transfer. CXL is particularly useful in data-centric applications, such as artificial intelligence, machine learning, and advanced computing workloads, where rapid access to large amounts of data is critical for performance.

Compute Express Link aims to enhance system performance and efficiency by providing a standardized interface that can handle diverse data types and workloads. It supports three key protocols:
CXL.io: Focuses on I/O operations, enabling efficient data transfer between devices.
CXL.cache: Facilitates caching operations, ensuring timely access to frequently used data.
CXL.memory: Optimizes memory usage and management, allowing for faster data processing.

This innovative technology is paving the way for more integrated and powerful computing systems, enabling seamless communication and data sharing between various hardware components.

On the Host side, the complexity and hardware tax of scaling ordered IO bandwidth is significantly higher than scaling the unordered IO flows. Allowing a mode in the protocol to scale unordered IO bandwidth independent of ordered IO bandwidth will enable faster time to market (TTM) for the Host as well as flexibility on hardware cost and platform considerations for different Stock Keeping Units (SKUs) (since Unordered IO scaling requires significantly less area, and hence less power, such a mode can enable the host to have more IO lanes in the same die area).

No previous solution-PCIe/CXL.io require the same bandwidth support for Unordered IO and Ordered IO Transaction Layer Packets (TLPs).

Example embodiments of the present disclosure relate to systems, methods, and devices for bandwidth scaling knobs for PCIe/CXL.io using unordered IO as primary vehicle.

In one or more embodiments, a bandwidth scaling system may facilitate a concept of a special protocol feature in PCIe/CXL.io that allows independent advertisement of maximum bandwidth supported by the receiver UIO vs non-UIO VCs (e.g., virtual channels).

In one or more embodiments, a bandwidth scaling system may facilitate details of negotiations, Flit packing rules, flow control, PM, and other protocol related differences associated for this mode from a PCIe/CXL.io specification perspective.

Flits (Flow Control Units): In high-speed data communication, a flit is a basic unit of data transfer, especially in architectures like CXL. Flits are often used for efficient data movement within a system.

In one or more embodiments, a bandwidth scaling system may facilitate high-level implementation example of functionality partitioning and optimizations using the Host IO stack as an example to illustrate the benefits of independent scaling of the bandwidth associated with UIO.

One or more advantages include at least the following:
1) Flexibility for Devices and Hosts to scale UIO bandwidth independent of non-UIO bandwidth. This results in die area savings, faster time to market (TTM), and more flexibility on platform configurations (aka can have more IO lanes in the same die area).
2) Allows for Device to move to UIO as a primary direct memory access (DMA) mode, which gives synergy for back-side fabric use cases as well as device to host connection scaling.

It should be noted that when discussing “bandwidth scaling knobs,” it refers to various adjustable parameters or settings that can influence the bandwidth performance of the PCIe interface. These knobs might include the number of data lanes, the generation of the PCIe standard being used, settings in the system BIOS, and other factors that can be configured or optimized to achieve desired performance outcomes.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

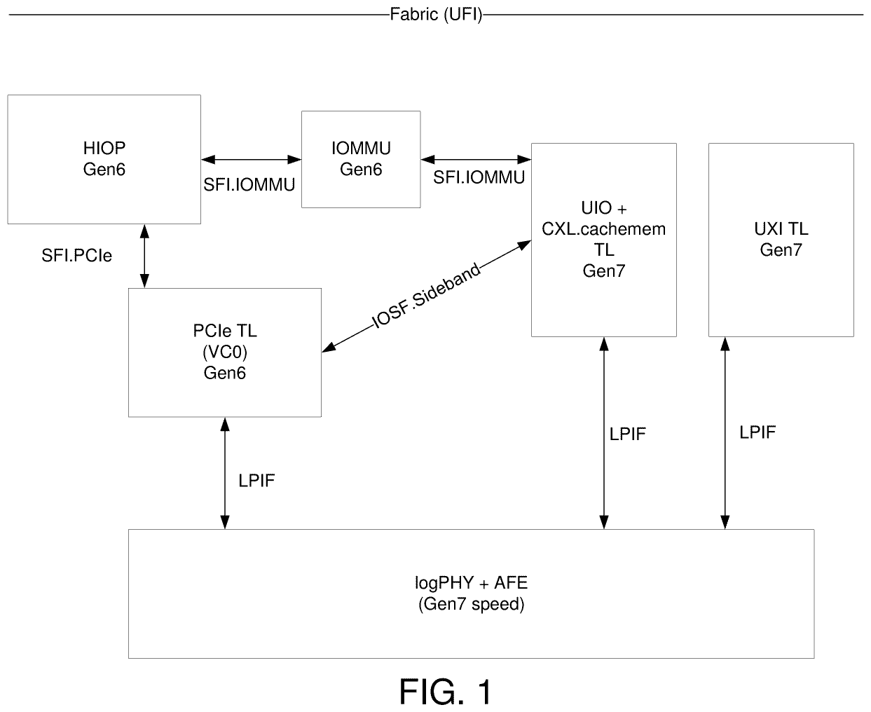

FIG. 1 depicts an illustrative schematic diagram for bandwidth scaling, in accordance with one or more example embodiments of the present disclosure.

Negotiation of this mode in PCIe Configuration state of link training and status state machine (LTSSM):

Flit_Mode_Enabled variable is set in Configuration. Linkwidth.Accept state. If Flit_Mode_Enabled is 1b, support of this mode is advertised in TS1/TS2 starting from Configuration.Lanenum.Accept. If both sides support this mode, Tx takes note of it from TS2 in Configuration.Complete and guarantees to not send UIO or non-UIO Flits at a higher bandwidth than what the Rx advertised. The same negotiation is used for PCIe and CXL protocols.

Here is a breakdown of the above paragraph for convenience:
Flit_Mode_Enabled variable is set in Configuration.Linkwidth.Accept state.
Flit_Mode_Enabled refers to a setting that allows the system to communicate whether flit mode is enabled or not during link width adjustment.

If Flit_Mode_Enabled is 1b, support of this mode is advertised in TS1/TS2 starting from Configuration.Lanenum.Accept.

TS1/TS2 are training sequences used in PCIe to establish communication parameters between devices. When Flit_Mode_Enabled is set to 1b, it signals that the mode is active, starting from the lane enumeration phase.

If both sides support this mode, Tx takes note of it from TS2 in Configuration.Complete and guarantees to not send UIO or non-UIO Flits at a higher bandwidth than what the Rx advertised.

This means that if both the transmitter (Tx) and receiver (Rx) agree on using flit mode, the transmitter will ensure it does not exceed the receiver's advertised bandwidth capability.

The same negotiation is used for PCIe and CXL protocols.

PCIe stands for Peripheral Component Interconnect Express, which is a high-speed interface standard for connecting peripherals to a computer. CXL, or Compute Express Link, is a newer protocol designed for high-speed CPU-to-device and CPU-to-memory communication.

The N_FTS byte (byte 3) of the Training Sequences (both TS1 and TS2) is used to advertise this mode using the following encodings:

| Bit Position | Description |
|---|---|
| [2:0] | Maximum Bandwidth supported for non-UIO |
| | VCs |
| | 000b: Full bandwidth as the advertised data |
| | rate |
| | 001b: Bandwidth corresponding to 8 GT/s |
| | 010b: Bandwidth corresponding to 16 GT/s |
| | 011b: Bandwidth corresponding to 32 GT/s |
| | 100b: Bandwidth corresponding to 64 GT/s |
| | Other encodings: Reserved. If this field is not |
| | 000b and Flit_Mode_Enabled is 1b, then |
| | bit[7] must be 1b. |
| [5:3] | Maximum Bandwidth supported for UIO VCs |
| | 000b: Full bandwidth as the advertised data |
| | rate |
| | 001b: Bandwidth corresponding to 64 GT/s |
| | Other encodings: Reserved. |
| | If this field is not 000b and |
| | Flit_Mode_Enabled is 1b, then bit[7] must be |
| | 1b. |
| [6] | Reserved |
| [7] | 0b: Throttling mode not supported |
| | 1b: Throttling mode supported |
| | This field is there to advertise Throttling |
| | mode for lower data rates (as low as 8 GT/s) |
| | as well (just as Flit Mode can be advertised |
| | for lower data rates) |

In the context provided, the “b” denotes binary representation. It indicates that the values are expressed in binary format, where each digit represents a binary bit. For example, “001b” translates to the binary number 001, which is equivalent to the decimal number 1.

If the advertised data rate is 128GT/s, the transmitter must be capable of supporting the Throttling mode for all the possible advertised encodings in non-UIO VCs in the above table.

As an example, consider Host A connected to Device B. If the negotiated data rate is 128GT/s, but Device B receiver advertised 100b for non-UIO VCs encoding from the above table, and UIO VCs advertised 000b encoding from the above table, AND both sides of the Link advertised support of the throttling mode, then the Transmitter on Host A must guarantee that it will never send back-to-back Flits containing TLPs/DLLPs for non-UIO VCs (i.e. it will either insert NOPs or Payload Flits of UIO VCs between consecutive Flits carrying non-UIO VCs).

Here is a breakdown of the above paragraph for convenience:

If the advertised data rate is 128GT/s, the transmitter must be capable of supporting the Throttling mode for all the possible advertised encodings in non-UIO VCs in the above table. This means that the transmitter must ensure compatibility with different encoding schemes listed for non-User IO VCs, facilitating smooth data transfer even at high speeds.

As an example, consider Host A connected to Device B. Host A and Device B represent two devices in a network where Host A acts as the sender and Device B acts as the receiver. If the negotiated data rate is 128GT/s, but Device B receiver advertised 100b for non-UIO VCs encoding from the above table, and UIO VCs advertised 000b encoding from the above table, AND both sides of the Link advertised support of the throttling mode, then the Transmitter on Host A must guarantee that it will never send back-to-back Flits containing TLPs/DLLPs for non-UIO VCs (i.e. it will either insert NOPs or Payload Flits of UIO VCs between consecutive Flits carrying non-UIO VCs). In this scenario, Host A must ensure that data packets (Flits) are interspersed with idle packets (NOPs) or UIO VC packets to maintain the integrity and efficiency of the throttling mode.

### Definitions

Flit: A unit of data used in high-speed networks.
TLP: Transaction Layer Packet, a type of data packet in PCIe networks.
DLLP: Data Link Layer Packet, another type of data packet in PCIe networks.
UIO: User Input/Output, representing data channels specifically for user-related transactions.
NOP: No Operation Packet, an idle packet used to fill gaps between data packets.
Encoding: The process of converting data into a specific format.

### Example

Host A could be a computer server, while Device B could be a storage device. If the server and storage device are communicating at a high speed of 128GT/s, but the storage device can only handle certain encoding schemes (say it uses encoding 100b for non-user data channels and 000b for user data channels), the server must insert idle packets or user data packets to avoid sending continuous non-user data packets. This ensures smooth operation and prevents data overload.

To enable this mode and scaling for 128GT/s bandwidth in general, the following additional rules for TLP packing within a Flit are added:

A Transaction Layer Packet (TLP) is a fundamental unit of data used in PCI Express (PCIe) networks. These packets are responsible for delivering high-level commands and data between connected devices, such as computers and storage systems. TLPs contain information about transactions, such as read and write requests, address locations, and data payloads, ensuring that communication is efficient and reliable. In the context of throttling modes and various Virtual Channels (VCs), TLPs must be carefully managed and interspersed with Idle Packets (NOPs) or User Input/Output (UIO) VC packets to maintain performance and prevent data overload.

It should be noted that throttle mode refers to a mechanism that regulates the data transmission rate based on the device's advertised bandwidth capabilities and the negotiated data rate. Essentially, it controls how fast data packets (Flits) are sent, ensuring efficient communication while preventing overload or congestion. Throttling can be particularly useful in high-speed data transfer scenarios, where different virtual channels (UIO and non-UIO) need to be managed effectively. It helps balance performance by adjusting the flow of data, sometimes inserting NOPs (no operation packets) or interleaving Flits to optimize transmission

TLPs from non-UIO VCs and UIO VCs are not allowed to be part of the same Flit. This is to ensure the throttling can be done at a Flit level, even for Replays etc.

Non-UIO VCs are channels used for data transactions that are unrelated to user input or output. These channels handle all other types of data traffic, such as system control messages, regular data transfers, and other non-user-specific communications. In high-speed networks, non-UIO VCs are essential for maintaining the efficiency and performance of the system by allowing the segregation of different types of data, thereby optimizing the flow and processing of information.

It is permitted to interleave Flits between UIO and non-UIO VCs. This means that a TLP from a non-UIO VC that began in Flit 0 and requires more than a Flit to be transferred can begin in Flit 0, skip Flit 1 (if Flit 1 was for UIO VCs) and continue from Flit 2 (if it is for non-UIO VC). The number of UIO VC Flits (or No OPeration packets (NOPs)) between consecutive non-UIO Flits is determined by the current Link Speed and the advertised bandwidth of the receiver of the remote Link partner. In the previous example, it was 1 since the negotiated data rate was 128GT/s. But if the negotiated data rate was 64GT/s for any reason, back-to-back Flits with the non-UIO VCs would be permitted since the Receiver advertised that it could handle that data rate.

For PCIe, the Flit Usage encoding bits would be enhanced so that the Flits with UIO vs non-UIO VCs can be differentiated:
00b IDLE Flit or NOP Flit.
01b Payload Flit if Throttling mode was not negotiated, OR Payload Flit for UIO VCs if Throttling mode was negotiated.
10b Payload Flit for non-UIO VCs if Throttling mode was negotiated else reserved.
11b Reserved.

For CXL, there are no-free encodings in the Flit Header/Flit Type currently as shown below:

TABLE 6-5
256B Flit Header

| Filt Header | Flit Header | |
|---|---|---|
| Field | Bit Location | Description |
| Flit | [7:6] | 00b = Physical Layer IDLE flit or |
| Type[1:0] | | Physical Layer NOP flit or CXL.io |
| | | NOP flit |
| | | 01b = CXL.io Payload flit |
| | | 10b = CXL.cachemem Payload flit or |
| | | CXL.cachemem-generated Empty flit |
| | | 11b = ALMP |
| | | Please refer to Table 6-5 more details. |
| Prior | [5] | 0 = Prior flit was a [symbol] NOP; or |
| Flit Type | | IDLE flit (not allocated into Replay |
| | | buffer) |
| | | 1 = Prior flit was a Payload flit or |
| | | Empty flit (allocated into Replay |
| | | buffer) |
| Type of | [4] | If (Flit Type = (CXL.io Payload or |
| DLLP | | CXL.io NOP): Use as defined in PCIe |
| Payload | | Base Specification |
| | | If (Flit Type != (CXL.io Payload or |
| | | CXL.io NOP)): Reserved |
| Replay | [3:2] | Same as defined in PCIe Base |
| Command[1:0] | | Specification. |
| Flit Sequence | {[1:0], | 10-bit Sequence Number as defined in |
| Number[9:0] | [15:8]} | PCIe Base Specification. |

The new encodings for Flit Type will be as follows if Throttling Mode was negotiated:
00b Physical Layer IDLE Flit or Physical Layer NOP Flit or CXL.io NOP Flit or ALMP.
01b CXL.io Payload Flit for UIO VCs.
10b CXL.cachemem Payload Flit or CXL.cachemem generated Empty Flit.
11b CXL.io Payload Flit for non-UIO VCs.

For 00b Flit Type Flits, Byte 0 and Byte 1 are the Flit Header, Byte 2 and Byte 3 will carry additional information as below, and Bytes 4, 5, 6 and 7 will be the ALMP when carrying an ALMP. If carrying an ALMP, these Flits go through the Retry buffers, and the Tx must not set the Prior Flit Type as 0b in the subsequent Flit.

Byte 2 bit 0: if 0b, indicates NOP or IDLE, if 1b, indicates an ALMP is present in this Flit.

Other bits of Byte 2 and Byte 3 are reserved.

TLP headers are only permitted to begin at 16 byte granularity. For PCIe, this would be byte 0, byte 16 and so on. For CXL, for Option 1, it would be Byte 2, byte 18, and so on; for Option 2, it would be Byte 4, Byte 20, and so on.

Flow control rules:
VC3 and VC4 (UIO VCs) cannot be part of the VC0 shared pool for credits, they can be their own dedicated credits and presumably should be smaller than current buffer sizes because of below.
If you negotiate this mode, only translated requests can come on UIO. These must be 64B address and length aligned.
ATS requests for PCIe continue to be on VC0 for PCIe.

### Other Flows:

When the Throttling mode is negotiated, L1/L2/L0p negotiation on PCIe/CXL Link does not change (still through DLLPs proxied in the PCIe/CXL.io TL), however the controller needs to make sure it takes into account the UIO state before responding to the DLLP handshakes.

Add the following registers for this feature (the actual bit position and location would be determined at the time of incorporation into the relevant specifications):

1) Capability:

| Bit Location | Field | Attribute |
|---|---|---|
| 0 | Throttling Mode supported: When set, | HwInit |
| | indicates support for Throttling Mode. | |
| | Must be clear by implementations that do | |
| | not support Throttling Mode or Flit Mode. | |
| | Support is Mandatory for implementations | |
| | that advertise a data rate of 128 GT/s. | |
| 3:1 | Receiver non-UIO Maximum Bandwidth: The | HwInit |
| | encodings and values are the same as | |
| | those advertised in TS1/TS2. | |
| 6:4 | Receiver UIO Maximum Bandwidth: The | HwInit |
| | encodings and values are the same as | |
| | those advertised in TS1/TS2. | |

Control:

| Bit Location | Field | Attribute |
|---|---|---|
| 0 | Throttling Mode Disable: When set, the | RW |
| | Port is not permitted to set Throttling | |
| | mode supported bit in the training | |
| | sets. It also implies that 128 GT/s data | |
| | rate cannot be advertised if this is set. | |

2) Status:

| Bit Location | Field | Attribute |
|---|---|---|
| 0 | Throttling Mode status: When Throttling | RO |
| | Mode Supported is set, this bit when | |
| | set indicates that the Link will be | |
| | operating in Throttling Mode. | |
| 3:1 | Remote Link partner's Receiver | RO |
| | non-UIO Maximum | |
| | Bandwidth: The encodings and values | |
| | are the same as those advertised | |
| | in TS1/TS2 by the Remote Link partner. | |
| 6:4 | Remote Link partner's Receiver | RO |
| | UIO Maximum | |
| | Bandwidth: The encodings and values | |
| | are the same as those advertised | |
| | in TS1/TS2 by te Remote Link partner. | |

The following abbreviations are used:
RO: Read Only
RW: Read Write
R/W: Read Write. The value read may not be the last value written.
RWC: Read/Write ‘1’ to clear
RWS: Read/Write ‘1’ to set
Impl Spec: Implementation Specific—the controller has the freedom to choose its implementation.
HwInit: The default state is dependent on device and system configuration. The value is initialized at reset, for example by an expansion ROM, or in the case of integrated devices, by a platform BIOS.

### Implementation View:

In order to facilitate faster TTM and longer-term convergence with multiple auxillary Link features in CXL, the current example of a Host implementation presented will absorb the unordered IO flows within the CXL.cachemem controller. The UIO TLP mapping to IDI can be implemented without the need for maintaining cache state within the CXL.cachemem controller itself, so they are similar to CXL.cache flows once broken up into cache-line or sub-cacheline transactions. UIO reads map to RdCurr opcode on IDI, and UIO writes map to ItoMWr opcode on IDI. The estimate for UIO TLP parsing and flows is roughly 10-20% more than the area of the UXI TL (about 0.5 sqmm) which is less than 1% of the overall area of the IO stack, so this trade-off for faster TTM is reasonable.

Referring to FIG. 1, there is shown an example implementation.

Flexbus log PHY may scale to support the full data rate of 128GT/s, for the FEC/CRC logic, it can re-use the existing gen6 blocks (by replicating them and sending odd sequence numbers to one set, and even sequence numbers to another set), or enhance the existing code to parse 256B of data at a time.

The strongly ordered path (PCIe TL, HIOP, IOMMU) remains at gen 6 bandwidth capabilities. The UIO VCs get routed to the UIO+CXL.cachemem controller for both PCIe and CXL modes.

For PCIe mode, for PM flows and register accesses, the PCIe TL uses the IOSF sideband Link to co-ordinate the UIO state with the UIO+CXL.cachemem controller.

The SFI.IOMMU connection between the UIO+CXL.cachemem controller and IOMMU is present to perform secure-ATS related checks. It has not been shown that the encryption logic in this picture, but that would follow the encryption rules of the corresponding specification. In future, a Flit level encryption scheme would make sense that is common across all protocols, but the details of this are outside the scope of this disclosure.

To clarify, the Flexbus log PHY is designed to scale to support a data rate of 128GT/s. For the Forward Error Correction (FEC) and Cyclic Redundancy Check (CRC) logic, there are two options: either replicate the existing gen6 blocks and alternate sequence numbers or enhance existing code to parse 256 bytes of data at one go.

The strongly ordered path, which includes PCIe Transaction Layer (TL), Host IO Path (HIOP), and I/O Memory Management Unit (IOMMU), will continue to operate at gen6 bandwidth capacities. This ensures that traditional data paths maintain their performance while UIO Virtual Channels (VCs) are directed to the UIO+CXL.cachemem controller for both PCIe and CXL modes.

In PCIe mode, when dealing with Power Management (PM) flows and register accesses, the PCIe TL uses the IOSF sideband link to coordinate the UIO state with the UIO+CXL.cachemem controller. This coordination is crucial for maintaining consistency and performance across different data pathways.

There is also a Secure Fault Isolation (SFI) IOMMU connection between the UIO+CXL.cachemem controller and the IOMMU, which is necessary for secure Address Translation Services (ATS) related checks. Although the encryption logic is not detailed in this context, future implementations might incorporate a Flit level encryption scheme that applies uniformly across all protocols, ensuring higher security standards.

It is understood that the above descriptions are for the purposes of illustration and are not meant to be limiting.

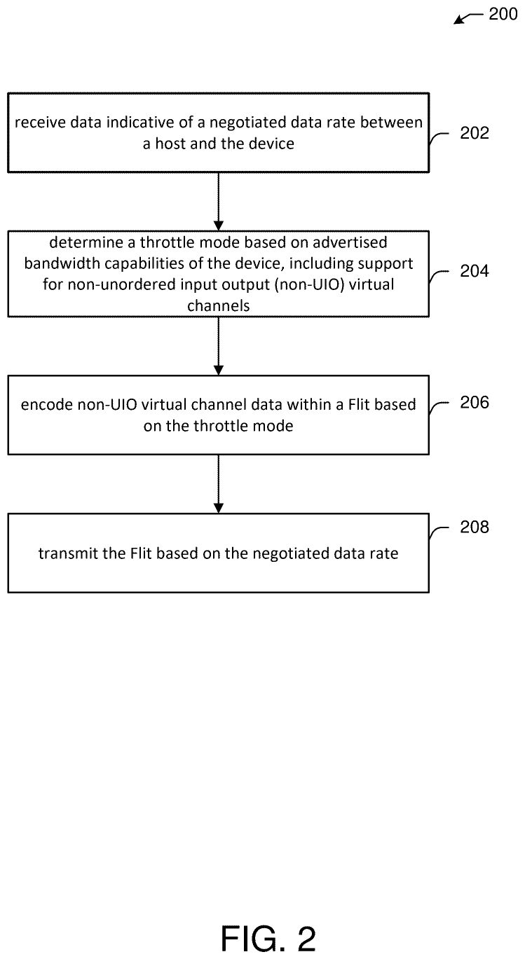

FIG. 2 illustrates a flow diagram of illustrative process 200 for a bandwidth scaling system, in accordance with one or more example embodiments of the present disclosure.

At block 202, a device may receive data indicative of a negotiated data rate between a host and the device.

At block 204, the device may determine a throttle mode based on advertised bandwidth capabilities of the device, including support for non-unordered input output (non-UIO) virtual channels.

At block 206, the device may encode non-UIO virtual channel data within a Flit based on the throttle mode.

At block 208, the device may transmit the Flit based on the negotiated data rate.

In one or more embodiments, the device may interleave Flits of UIO and non-UIO virtual channels. The device may utilize TLP headers starting at 16-byte granularity. The device may encode TLPs from non-UIO virtual channels and UIO virtual channels in separate Flits. The device may insert NOPs or UIO virtual channel Payload Flits between consecutive non-UIO virtual channel Flits. The device may determine a number of UIO virtual channel Flits or NOPs based on the negotiated data rate and the advertised bandwidth capabilities. The device may support a data rate of up to 128 GT/s. The device may support the throttling mode for lower data rates as low as 8 GT/s. The device may omit sending back-to-back Flits containing TLPs or DLLPs for non-UIO virtual channels. The device may store computer-executable instructions which, when executed by one or more processors, may result in performing operations comprising: receiving data indicative of a negotiated data rate between a host and the device; determining a throttle mode based on advertised bandwidth capabilities of the device, including support for non-UIO virtual channels; encoding non-UIO virtual channel data within a Flit based on the throttle mode; and transmitting the Flit based on the negotiated data rate. The device may interleave Flits of UIO and non-UIO virtual channels. The device may utilize TLP headers starting at 16-byte granularity. The device may encode TLPs from non-UIO virtual channels and UIO virtual channels in separate Flits. The device may insert NOPs or UIO virtual channel Payload Flits between consecutive non-UIO virtual channel Flits. The device may determine a number of UIO virtual channel Flits or NOPs based on the negotiated data rate and the advertised bandwidth capabilities.

It is understood that the above descriptions are for the purposes of illustration and are not meant to be limiting.

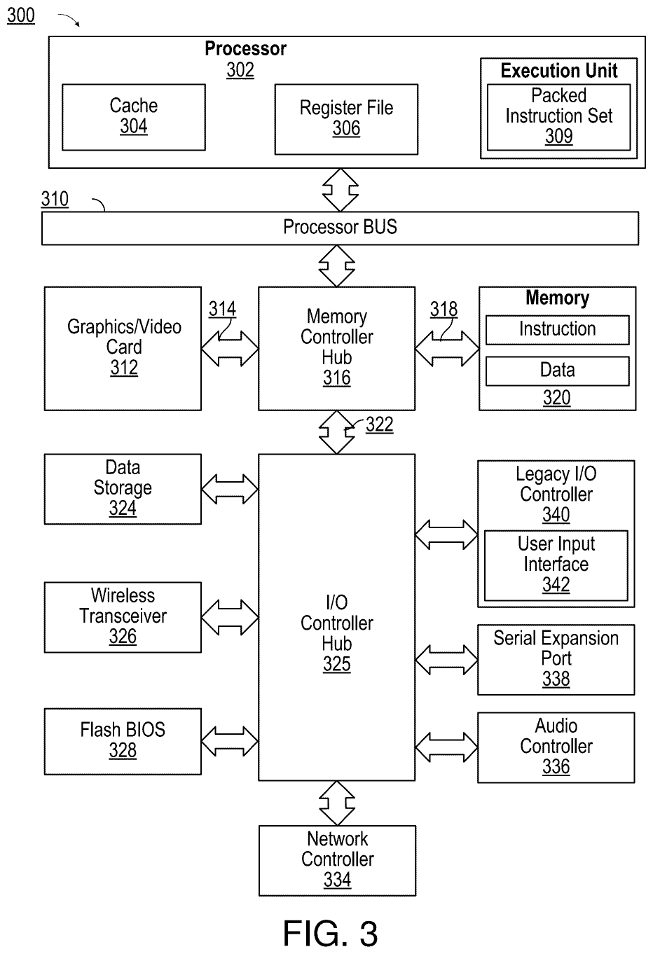

Turning to FIG. 3, a block diagram of an exemplary computer system formed with a processor that includes execution units to execute an instruction, where one or more of the interconnects implement one or more features in accordance with one embodiment of the present disclosure is illustrated. System 300 includes a component, such as a processor 302 to employ execution units including logic to perform algorithms for process data, in accordance with the present disclosure, such as in the embodiment described herein. In one embodiment, sample system 300 executes a version of an operating system and included software, and provides corresponding graphical user interfaces, may also be used. However, embodiments of the present disclosure are not limited to any specific combination of hardware circuitry and software.

Embodiments are not limited to computer systems. Alternative embodiments of the present disclosure can be used in other devices such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 302 includes one or more execution units 308 to implement an algorithm that is to perform at least one instruction. One embodiment may be described in the context of a single processor desktop or server system, but alternative embodiments may be included in a multiprocessor system. System 300 is an example of a ‘hub’ system architecture. The computer system 300 includes a processor 302 to process data signals. The processor 302, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 302 is coupled to a processor bus 310 that transmits data signals between the processor 302 and other components in the system 300. The elements of system 300 (e.g. graphics accelerator 312, memory controller hub 316, memory 320, I/O controller hub 325, wireless transceiver 326, Flash BIOS 328, Network controller 334, Audio controller 336, Serial expansion port 338, I/O controller 340, etc.) perform their conventional functions that are well known to those familiar with the art.

In one embodiment, the processor 302 includes a Level 1 (L1) internal cache memory 304. Depending on the architecture, the processor 302 may have a single internal cache or multiple levels of internal caches. Other embodiments include a combination of both internal and external caches depending on the particular implementation and needs. Register file 306 is to store different types of data in various registers including integer registers, floating point registers, vector registers, banked registers, shadow registers, checkpoint registers, status registers, and instruction pointer register.

Execution unit 308, including logic to perform integer and floating point operations, also resides in the processor 302. The processor 302, in one embodiment, includes a microcode (ucode) ROM to store microcode, which when executed, is to perform algorithms for certain macroinstructions or handle complex scenarios. Here, microcode is potentially updateable to handle logic bugs/fixes for processor 302. For one embodiment, execution unit 308 includes logic to handle a packed instruction set 309. By including the packed instruction set 309 in the instruction set of a general-purpose processor 302, along with associated circuitry to execute the instructions, the operations used by many multimedia applications may be performed using packed data in a general-purpose processor 302. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 308 may also be used in micro controllers, embedded processors, graphics devices, DSPs, and other types of logic circuits. System 300 includes a memory 320. Memory 320 includes a dynamic random access memory (DRAM) device, a static random access memory (SRAM) device, flash memory device, or other memory device. Memory 320 stores instructions and/or data represented by data signals that are to be executed by the processor 302.

Note that any of the aforementioned features or aspects of the present disclosure and solutions may be utilized on one or more interconnect illustrated in FIG. 3. For example, an on-die interconnect (ODI), which is not shown, for coupling internal units of processor 302 implements one or more aspects of the embodiments described above. Or the embodiments may be associated with a processor bus 310 (e.g. other known high performance computing interconnect), a high bandwidth memory path 318 to memory 320, a point-to-point link to graphics accelerator 312 (e.g. a Peripheral Component Interconnect express (PCIe) compliant fabric), a controller hub interconnect 322, an I/O or other interconnect (e.g. USB, PCI, PCIe) for coupling the other illustrated components. Some examples of such components include the audio controller 336, firmware hub (flash BIOS) 328, wireless transceiver 326, data storage 324, legacy I/O controller 325 containing user input and keyboard interfaces 342, a serial expansion port 338 such as Universal Serial Bus (USB), and a network controller 334. The data storage device 324 can comprise a hard disk drive, a floppy disk drive, a CD-ROM device, a flash memory device, or other mass storage device.

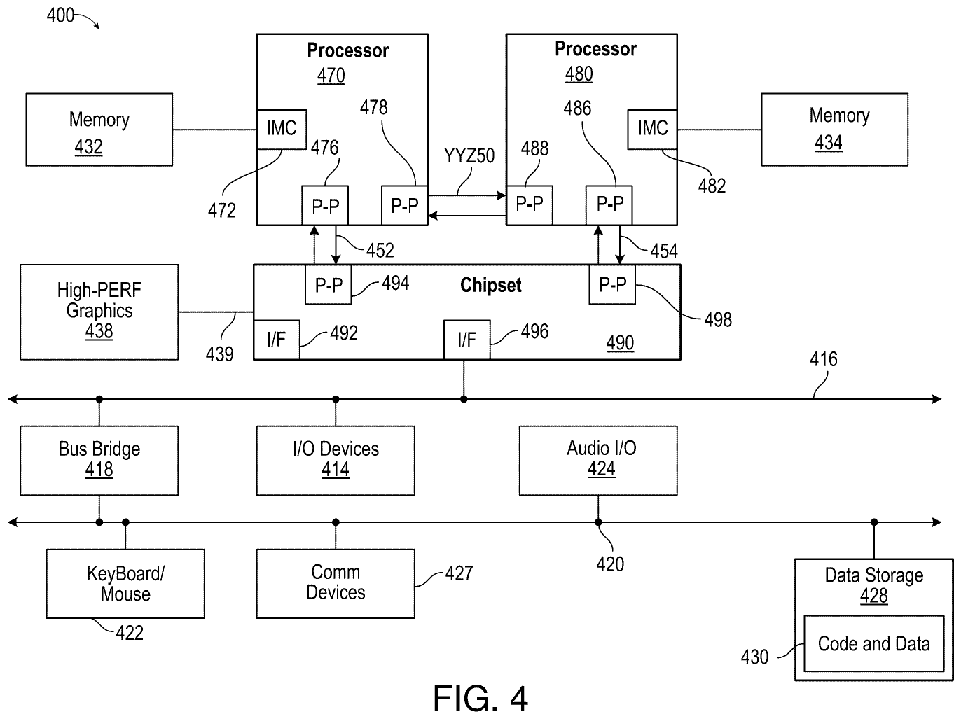

Referring now to FIG. 4, shown is a block diagram of a second system 400 in accordance with an embodiment of the present disclosure. As shown in FIG. 4, multiprocessor system 400 is a point-to-point interconnect system, and includes a first processor 470 and a second processor 480 coupled via a point-to-point interconnect 450. Each of processors 470 and 480 may be some version of a processor. In one embodiment, 452 and 454 are part of a serial, point-to-point coherent interconnect fabric, such as a high-performance architecture.

While shown with only two processors, 470, 480, it is to be understood that the scope of the present disclosure is not so limited. In other embodiments, one or more additional processors may be present in a given processor.

Processors 470 and 480 are shown including integrated memory controller units 472 and 482, respectively. Processor 470 also includes as part of its bus controller units point-to-point (P-P) interfaces 476 and 478; similarly, second processor 480 includes P-P interfaces 486 and 488. Processors 470, 480 may exchange information via a point-to-point (P-P) interface 450 using P-P interface circuits 478, 488. As shown in FIG. 4, IMCs 472 and 482 couple the processors to respective memories, namely a memory 432 and a memory 434, which may be portions of main memory locally attached to the respective processors.

Processors 470, 480 each exchange information with a chipset 490 via individual P-P interfaces 452, 454 using point to point interface circuits 476, 494, 486, 498. Chipset 490 also exchanges information with a high-performance graphics circuit 438 via an interface circuit 492 along a high-performance graphics interconnect 439.

A shared cache (not shown) may be included in either processor or outside of both processors; yet connected with the processors via P-P interconnect, such that either or both processors' local cache information may be stored in the shared cache if a processor is placed into a low power mode.

Chipset 490 may be coupled to a first bus 416 via an interface 496. In one embodiment, first bus 416 may be a Peripheral Component Interconnect (PCI) bus, or a bus such as a PCI Express bus or another third generation I/O interconnect bus, although the scope of the present disclosure is not so limited.

As shown in FIG. 4, various I/O devices 414 are coupled to first bus 416, along with a bus bridge 418 which couples first bus 416 to a second bus 420. In one embodiment, second bus 420 includes a low pin count (LPC) bus. Various devices are coupled to second bus 420 including, for example, a keyboard and/or mouse 422, communication devices 427 and a storage unit 428 such as a disk drive or other mass storage device which often includes instructions/code and data 430, in one embodiment. Further, an audio I/O 424 is shown coupled to second bus 420. Note that other architectures are possible, where the included components and interconnect architectures vary. For example, instead of the point-to-point architecture of FIG. 4, a system may implement a multi-drop bus or other such architecture.

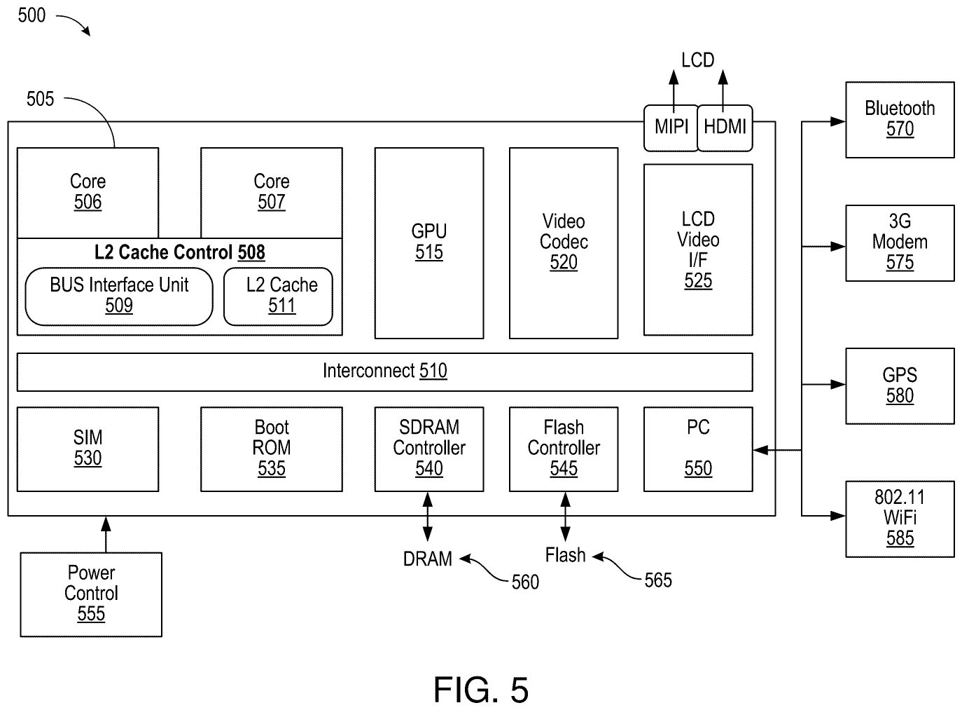

Turning next to FIG. 5, an embodiment of a system on-chip (SOC) design in accordance with the above disclosure is depicted. As a specific illustrative example, SOC 500 is included in user equipment (UE). In one embodiment, UE refers to any device to be used by an end-user to communicate, such as a hand-held phone, smartphone, tablet, ultra-thin notebook, notebook with broadband adapter, or any other similar communication device. Often a UE connects to a base station or node, which potentially corresponds in nature to a mobile station (MS) in a GSM network.

Here, SOC 500 includes 2 cores-506 and 507. Similar to the discussion above, cores 506 and 507 may conform to an Instruction Set Architecture, such as an Intel® Architecture Core™-based processor, an Advanced Micro Devices, Inc. (AMD) processor, a MIPS-based processor, an ARM-based processor design, or a customer thereof, as well as their licensees or adopters. Cores 506 and 507 are coupled to cache control 508 that is associated with bus interface unit 509 and L2 cache 511 to communicate with other parts of system 500. Interconnect 510 includes an on-chip interconnect, such as an IOSF, AMBA, or other interconnect discussed above, which potentially implements one or more aspects described herein.

Interconnect 510 provides communication channels to the other components, such as a Subscriber Identity Module (SIM) 530 to interface with a SIM card, a boot ROM 535 to hold boot code for execution by cores 506 and 507 to initialize and boot SOC 500, a SDRAM controller 540 to interface with external memory (e.g. DRAM 560), a flash controller 545 to interface with non-volatile memory (e.g. Flash 565), a peripheral control 550 (e.g. Serial Peripheral Interface) to interface with peripherals, video codecs 520 and Video interface 525 to display and receive input (e.g. touch enabled input), GPU 515 to perform graphics related computations, etc. Any of these interfaces may incorporate aspects of the embodiments described herein.

In addition, the system illustrates peripherals for communication, such as a Bluetooth module 570, 3G modem 575, GPS 580, and WiFi 585. Note as stated above, a UE includes a radio for communication. As a result, these peripheral communication modules are not all required. However, in the UE some form of radio for external communication is to be included.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expressions “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, yet still co-operate or interact with each other.

In addition, in the foregoing Detailed Description, various features are grouped together in a single example to streamline the disclosure. This method of disclosure is not to be interpreted as reflecting an intention that the claimed examples require more features than are expressly recited in each claim. Rather, as the following claims reflect, the inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Logic circuitry, devices, and interfaces herein described may perform functions implemented in hardware and implemented with code executed on one or more processors. Logic circuitry refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chipset, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits to perform one or more sub-functions implemented to perform the overall function of the processor. One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

The logic as described above may be part of the design for an integrated circuit chip. The chip design is created in a graphical computer programming language, and stored in a computer storage medium or data storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly. The stored design is then converted into the appropriate format (e.g., GDSII) for the fabrication.

The resulting integrated circuit chips can be distributed by the fabricator in raw wafer form (that is, as a single wafer that has multiple unpackaged chips), as a bare die, or in a packaged form. In the latter case, the chip is mounted in a single chip package (such as a plastic carrier, with leads that are affixed to a motherboard or other higher-level carrier) or in a multichip package (such as a ceramic carrier that has either or both surface interconnections or buried interconnections). In any case, the chip is then integrated with other chips, discrete circuit elements, and/or other signal processing devices as part of either (a) an intermediate product, such as a processor board, a server platform, or a motherboard, or (b) an end product.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, and/or the like.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, cither temporally, spatially, in ranking, or in any other manner.

The term “appliance,” “computer appliance,” or the like, as used herein refers to a computer device or computer system with program code (e.g., software or firmware) that is specifically designed to provide a specific computing resource. A “virtual appliance” is a virtual machine image to be implemented by a hypervisor-equipped device that virtualizes or emulates a computer appliance or otherwise is dedicated to provide a specific computing resource.

The term “resource” as used herein refers to a physical or virtual device, a physical or virtual component within a computing environment, and/or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, workload units, and/or the like. A “hardware resource” may refer to compute, storage, and/or network resources provided by physical hardware element(s). A “virtualized resource” may refer to compute, storage, and/or network resources provided by virtualization infrastructure to an application, device, system, etc. The term “network resource” or “communication resource” may refer to resources that are accessible by computer devices/systems via a communications network. The term “system resources” may refer to any kind of shared entities to provide services, and may include computing and/or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with and/or equivalent to “communications channel,” “data communications channel,” “transmission channel,” “data transmission channel,” “access channel,” “data access channel,” “link,” “data link,” “carrier,” “radiofrequency carrier,” and/or any other like term denoting a pathway or medium through which data is communicated. Additionally, the term “link” as used herein refers to a connection between two devices through a RAT for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The terms “coupled,” “communicatively coupled,” along with derivatives thereof are used herein. The term “coupled” may mean two or more elements are in direct physical or electrical contact with one another, may mean that two or more elements indirectly contact each other but still cooperate or interact with each other, and/or may mean that one or more other elements are coupled or connected between the elements that are said to be coupled with each other. The term “directly coupled” may mean that two or more elements are in direct contact with one another. The term “communicatively coupled” may mean that two or more elements may be in contact with one another by a means of communication including through a wire or other interconnect connection, through a wireless communication channel or link, and/or the like.

The term “information element” refers to a structural element containing one or more fields. The term “field” refers to individual contents of an information element, or a data element that contains content.

The following examples pertain to further embodiments.

Example 1 may include a device comprising processing circuitry coupled to storage, the processing circuitry configured to: receive data indicative of a negotiated data rate between a host and the device; determine a throttle mode based on advertised bandwidth capabilities of the device, including support for non-unordered input output (non-UIO) virtual channels; encode non-UIO virtual channel data within a Flit based on the throttle mode; and transmit the Flit based on the negotiated data rate.

Example 2 may include the device of example 1 and/or some other example(s) herein, wherein the processing circuitry may be further configured to interleave Flits of UIO and non-UIO virtual channels.

Example 3 may include the device of example 1 and/or some other example(s) herein, wherein the processing circuitry may be further configured to utilize transaction layer packet (TLP) headers starting at 16-byte granularity.

Example 4 may include the device of example 1 and/or some other example(s) herein, wherein the processing circuitry may be further configured to encode transaction layer packets (TLPs) from non-UIO virtual channels and UIO virtual channels in separate Flits.

Example 5 may include the device of example 1 and/or some other example(s) herein, wherein the processing circuitry may be further configured to insert NOPs or UIO virtual channel Payload Flits between consecutive non-UIO virtual channel Flits.

Example 6 may include the device of example 1 and/or some other example(s) herein, wherein the processing circuitry may be further configured to determine a number of UIO virtual channel Flits or no operation packets (NOPs) based on the negotiated data rate and the advertised bandwidth capabilities.

Example 7 may include the device of example 1 and/or some other example(s) herein, wherein the processing circuitry may be further configured to support a data rate of up to 128 giga-transfers per second (GT/s).

Example 8 may include the device of example 1 and/or some other example(s) herein, wherein the processing circuitry may be further configured to support the throttling mode for lower data rates as low as 8 giga-transfers per second (GT/s).

Example 9 may include the device of example 1 and/or some other example(s) herein, wherein the processing circuitry may be further configured to omit sending back-to-back Flits containing TLPs or data link layer packets (DLLPs) for non-UIO virtual channels.

Example 10 may include a non-transitory computer-readable medium storing computer-executable instructions which when executed by one or more processors result in performing operations comprising: receiving data indicative of a negotiated data rate between a host and the device; determining a throttle mode based on advertised bandwidth capabilities of the device, including support for non-unordered input output (non-UIO) virtual channels; encoding non-UIO virtual channel data within a Flit based on the throttle mode; and transmitting the Flit based on the negotiated data rate.

Example 11 may include the non-transitory computer-readable medium of example 10 and/or some other example(s) herein, wherein the operations further comprise interleaving Flits of UIO and non-UIO virtual channels.

Example 12 may include the non-transitory computer-readable medium of example 10 and/or some other example(s) herein, wherein the operations further comprise utilizing transaction layer packet (TLP) headers starting at 16-byte granularity.

Example 13 may include the non-transitory computer-readable medium of example 10 and/or some other example(s) herein, wherein the operations further comprise encoding transaction layer packets (TLPs) from non-UIO virtual channels and UIO virtual channels in separate Flits.

Example 14 may include the non-transitory computer-readable medium of example 10 and/or some other example(s) herein, wherein the operations further comprise inserting NOPs or UIO virtual channel Payload Flits between consecutive non-UIO virtual channel Flits.

Example 15 may include the non-transitory computer-readable medium of example 10 and/or some other example(s) herein, wherein the operations further comprise determining a number of UIO virtual channel Flits or no operation packets (NOPs) based on the negotiated data rate and the advertised bandwidth capabilities.

Example 16 may include the non-transitory computer-readable medium of example 10 and/or some other example(s) herein, wherein the operations further comprise supporting a data rate of up to 128 giga-transfers per second (GT/s).

Example 17 may include the non-transitory computer-readable medium of example 10 and/or some other example(s) herein, wherein the operations further comprise supporting the throttling mode for lower data rates as low as 8 giga-transfers per second (GT/s).

Example 18 may include the non-transitory computer-readable medium of example 10 and/or some other example(s) herein, wherein the operations further comprise omit sending back-to-back Flits containing TLPs or data link layer packets (DLLPs) for non-UIO virtual channels.

Example 19 may include a method comprising: receiving data indicative of a negotiated data rate between a host and the device; determining a throttle mode based on advertised bandwidth capabilities of the device, including support for non-unordered input output (non-UIO) virtual channels; encoding non-UIO virtual channel data within a Flit based on the throttle mode; and transmitting the Flit based on the negotiated data rate.

Example 20 may include the method of example 19 and/or some other example(s) herein, further comprising interleaving Flits of UIO and non-UIO virtual channels.

Example 21 may include the method of example 19 and/or some other example(s) herein, further comprising utilizing transaction layer packet (TLP) headers starting at 16-byte granularity.

Example 22 may include the method of example 19 and/or some other example(s) herein, further comprising encoding transaction layer packets (TLPs) from non-UIO virtual channels and UIO virtual channels in separate Flits.

Example 23 may include the method of example 19 and/or some other example(s) herein, further comprising inserting NOPs or UIO virtual channel Payload Flits between consecutive non-UIO virtual channel Flits.

Example 24 may include the method of example 19 and/or some other example(s) herein, further comprising determining a number of UIO virtual channel Flits or no operation packets (NOPs) based on the negotiated data rate and the advertised bandwidth capabilities.

Example 25 may include the method of example 19 and/or some other example(s) herein, further comprising supporting a data rate of up to 128 giga-transfers per second (GT/s).

Example 26 may include the method of example 19 and/or some other example(s) herein, further comprising supporting the throttling mode for lower data rates as low as 8 giga-transfers per second (GT/s).

Example 27 may include the method of example 19 and/or some other example(s) herein, further comprising omit sending back-to-back Flits containing TLPs or data link layer packets (DLLPs) for non-UIO virtual channels.

Example 28 may include an apparatus comprising means for: receiving data indicative of a negotiated data rate between a host and the device; determining a throttle mode based on advertised bandwidth capabilities of the device, including support for non-unordered input output (non-UIO) virtual channels; encoding non-UIO virtual channel data within a Flit based on the throttle mode; and transmitting the Flit based on the negotiated data rate.

Example 29 may include the apparatus of example 28 and/or some other example(s) herein, further comprising interleaving Flits of UIO and non-UIO virtual channels.

Example 30 may include the apparatus of example 28 and/or some other example(s) herein, further comprising utilizing transaction layer packet (TLP) headers starting at 16-byte granularity.

Example 31 may include the apparatus of example 28 and/or some other example(s) herein, further comprising encoding transaction layer packets (TLPs) from non-UIO virtual channels and UIO virtual channels in separate Flits.

Example 32 may include the apparatus of example 28 and/or some other example(s) herein, further comprising inserting NOPs or UIO virtual channel Payload Flits between consecutive non-UIO virtual channel Flits.

Example 33 may include the apparatus of example 28 and/or some other example(s) herein, further comprising determining a number of UIO virtual channel Flits or no operation packets (NOPs) based on the negotiated data rate and the advertised bandwidth capabilities.

Example 34 may include the apparatus of example 28 and/or some other example(s) herein, further comprising supporting a data rate of up to 128 giga-transfers per second (GT/s).

Example 35 may include the apparatus of example 28 and/or some other example(s) herein, further comprising supporting the throttling mode for lower data rates as low as 8 giga-transfers per second (GT/s).

Example 36 may include the apparatus of example 28 and/or some other example(s) herein, further comprising omit sending back-to-back Flits containing TLPs or data link layer packets (DLLPs) for non-UIO virtual channels.

Example 37 may include one or more non-transitory computer-readable media comprising instructions to cause an electronic device, upon execution of the instructions by one or more processors of the electronic device, to perform one or more elements of a method described in or related to any of examples 1-36, or any other method or process described herein.

Example 38 may include an apparatus comprising logic, modules, and/or circuitry to perform one or more elements of a method described in or related to any of examples 1-36, or any other method or process described herein.

Example 39 may include a method, technique, or process as described in or related to any of examples 1-36, or portions or parts thereof.

Example 40 may include an apparatus comprising: one or more processors and one or more computer readable media comprising instructions that, when executed by the one or more processors, cause the one or more processors to perform the method, techniques, or process as described in or related to any of examples 1-36, or portions thereof.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
receive data indicative of a negotiated data rate between a host and the device;
determine a throttle mode based on advertised bandwidth capabilities of the device, including support for non-unordered input output (non-UIO) virtual channels;
encode non-UIO virtual channel data within a Flit based on the throttle mode; and
transmit the Flit based on the negotiated data rate.

2. The device of claim 1, wherein the processing circuitry is further configured to interleave Flits of UIO and non-UIO virtual channels.

3. The device of claim 1, wherein the processing circuitry is further configured to utilize transaction layer packet (TLP) headers starting at 16-byte granularity.

4. The device of claim 1, wherein the processing circuitry is further configured to encode transaction layer packets (TLPs) from non-UIO virtual channels and UIO virtual channels in separate Flits.

5. The device of claim 1, wherein the processing circuitry is further configured to insert NOPs or UIO virtual channel Payload Flits between consecutive non-UIO virtual channel Flits.

6. The device of claim 1, wherein the processing circuitry is further configured to determine a number of UIO virtual channel Flits or no operation packets (NOPs) based on the negotiated data rate and the advertised bandwidth capabilities.

7. The device of claim 1, wherein the processing circuitry is further configured to support a data rate of up to 128 giga-transfers per second (GT/s).

8. The device of claim 1, wherein the processing circuitry is further configured to support the throttling mode for lower data rates as low as 8 giga-transfers per second (GT/s).

9. The device of claim 1, wherein the processing circuitry is further configured to omit sending back-to-back Flits containing TLPs or data link layer packets (DLLPs) for non-UIO virtual channels.

10. A non-transitory computer-readable medium storing computer-executable instructions which when executed by one or more processors result in performing operations comprising:
receiving data indicative of a negotiated data rate between a host and the device;
determining a throttle mode based on advertised bandwidth capabilities of the device, including support for non-unordered input output (non-UIO) virtual channels;
encoding non-UIO virtual channel data within a Flit based on the throttle mode; and
transmitting the Flit based on the negotiated data rate.

11. The non-transitory computer-readable medium of claim 10, wherein the operations further comprise interleaving Flits of UIO and non-UIO virtual channels.

12. The non-transitory computer-readable medium of claim 10, wherein the operations further comprise utilizing transaction layer packet (TLP) headers starting at 16-byte granularity.

13. The non-transitory computer-readable medium of claim 10, wherein the operations further comprise encoding transaction layer packets (TLPs) from non-UIO virtual channels and UIO virtual channels in separate Flits.

14. The non-transitory computer-readable medium of claim 10, wherein the operations further comprise inserting NOPs or UIO virtual channel Payload Flits between consecutive non-UIO virtual channel Flits.

15. The non-transitory computer-readable medium of claim 10, wherein the operations further comprise determining a number of UIO virtual channel Flits or no operation packets (NOPs) based on the negotiated data rate and the advertised bandwidth capabilities.

16. The non-transitory computer-readable medium of claim 10, wherein the operations further comprise supporting a data rate of up to 128 giga-transfers per second (GT/s).

17. The non-transitory computer-readable medium of claim 10, wherein the operations further comprise supporting the throttling mode for lower data rates as low as 8 giga-transfers per second (GT/s).

18. The non-transitory computer-readable medium of claim 10, wherein the operations further comprise omit sending back-to-back Flits containing TLPs or data link layer packets (DLLPs) for non-UIO virtual channels.

19. A method comprising:
receiving data indicative of a negotiated data rate between a host and the device;
determining a throttle mode based on advertised bandwidth capabilities of the device, including support for non-unordered input output (non-UIO) virtual channels;
encoding non-UIO virtual channel data within a Flit based on the throttle mode; and
transmitting the Flit based on the negotiated data rate.

20. The method of claim 19, further comprising interleaving Flits of UIO and non-UIO virtual channels.
